(19) United States
(12) Patent Application Publication
(10) Pub. No.: US 2003/0005625 A1
(43) Pub. Date: Jan. 9, 2003

(54) TIERED PLANTER

(76) Inventor: Donald Reichert, Spokane, WA (US)

Correspondence Address: Burkhart & Burkhart, Patent Attorneys, 940 Dakota Avenue, Whitefish, MT, 59937, US

(21) Appl. No.: 09/899,737

(22) Filed: Jul. 5, 2001

(51) Int. Cl. A01G 9/02

(52) U.S. Cl. 47/65.5

(57) ABSTRACT

A tiered planter including a frame assembly includes at least one front frame member. Also included is at least one back frame member having a height greater than that of the at least one front frame member. At least one top frame member is connected to the at least one front frame member and to the at least one back frame member. A plurality of planter boxes is provided Each planter box has a four side walls, a bottom connecting the four side walls, and an open top. The planter boxes are adapted and constructed to contain live plant material and plant growing medium. A plurality of planter box supports are connected to the frame assembly. The planter box supports are adapted and constructed to removably secure the planter boxes in a tiered configuration with each of the respective tops of the planter boxes being secured at different heights.

### FIELD OF THE INVENTION

The invention relates generally to planters. Specifically, the invention relates to portable planters for use in limited spaces.

### BACKGROUND OF THE INVENTION

The use of horticultural containers or planters has enabled gardeners to enjoy their pastime in spaces that are otherwise unsuitable for plant material. Container gardens allow anything from an apartment terrace to an urban rooftop to become an oasis for horticultural hobbyists. Unfortunately, such gardens usually exist in limited spaces, and the containers must be moved for space or seasonal considerations.

Planter structures addressed to these situations are known per se. For example, U.S. Pat. No. 4,685,246 to Fennell is directed to a portable box garden assembly having a main elongated compartmentalized rectangular box and a raised center section. It contains nine compartments, six for low growing plants and three for taller plants. Four wheels at each corner aid in mobility with two locking wheels to ensure stability and prevent movement.

U.S. Pat. No. 5,501,040 to White-Wexler discusses a decorative, terraced planter provides separate plant beds in individual compartments defined within an integrally formed housing of rigid, unitary construction. Each compartment can hold plants and soil separately from those in the other compartments, so that a mix of plants having differing soil and watering needs can be grown together within the planter. The compartments have holes at their bottoms to permit excess water to escape, and the planter preferably has a drip pan beneath the housing to catch the excess water. Stand-offs between the housing and the drip pan permit evaporation of water from the drip pan. Preferably, the tops of the compartments are at different levels, so as to form tiers or rows of plant beds, one above another, much like those of a hillside, terraced garden.

U.S. Pat. No. 4,115,950 to Lantai sets forth method and apparatus for increasing the production of tuber-producing plants per unit area. A seed-tuber is planted in soil that is contained in a first box or frame unit. As the plant grows it develops new leaves and axil-buds. When the plant reaches a given height, which is different for different plants, a new layer of soil is added to the first box or frame unit. The new layer of soil does not completely cover the plant. Instead, a layer of soil is added such that the apical meristem is located at the soil surface or about one cm. below the soil surface. As the plant continues to grow another new layer of soil is again added in the manner described. When the level of the soil approaches the top of the first box or frame unit, a second box or frame unit designed to fit on top of the first box or frame unit is placed on top of the first box or frame unit. This second box or frame unit is open at the top and bottom, whereas the first box or frame unit may have a bottom plate. New layers of soil are then added in the second box or frame unit in the manner and at the times described above with reference to the first box or frame unit. This process is repeated with additional boxes or frame units being piled one on top of the other and new layers of soil added. After the last layer of soil has been added the plant is allowed to grow until it is ready for harvesting.

Although these arrangements offer some advantages over standard planter systems, they are relatively complex and expensive. It can be seen from the foregoing that the need exists for a simple, inexpensive tiered planter system that provides fabrication, portability, and functional advantages, overcoming the deficiencies of known arrangements.

### SUMMARY OF THE INVENTION

These and other objects are achieved by providing a tiered planter including a frame assembly including at least one front frame member. Also included is at least one back frame member having a height greater than that of the at least one front frame member. At least one top frame member is connected to the at least one front frame member and to the at least one back frame member. A plurality of planter boxes is provided Each planter box has a four side walls, a bottom connecting the four side walls, and an open top. The planter boxes are adapted and constructed to contain live plant material and plant growing medium. A plurality of planter box supports are connected to the frame assembly. The planter box supports are adapted and constructed to removably secure the planter boxes in a tiered configuration with each of the respective tops of the planter boxes being secured at different heights.

The front and rear frame members can be provided as cross supports. The top frame member can include top elements of a plurality of side supports, with the planter box supports provided as upper surfaces of the top elements.

The side supports can be embodied as a left front side support connected to a left rear side support, and a right front side support connected to a right rear side support. Tab-and-slot mechanisms connect the left front side support to the left rear side support and the right front side support to the right rear side support. The tab-and-slot mechanisms can be provided as a pair of horizontally parallel tabs adapted and constructed to interlock with a corresponding pair of horizontally parallel slot s.

A tiered planter in accordance with claim 5, wherein the cross supports comprise at least one front cross support connected between the left and right front side supports, and at least one rear cross support connected between the left and right rear side supports. Tab-and-slot mechanisms can be used to connect the at least one front cross support connected between the left and right front side supports, and the at least one rear cross support between the left and right rear side supports.

The at least one front cross support, the left and right front side supports, the at least one rear cross support, and the left and right rear side supports can be fabricated from a suitable rigid, durable, material such as plastic.

In another embodiment, the at least one top frame member can be provided as at least one substantially straight top frame member connected to form a downwardly extending angle between the at least one front frame member and the at least one back frame member. The frame assembly can be fabricated from wood.

The features of the invention believed to be patentable are set forth with particularity in the appended claims. The invention itself, however, both as to organization and method of operation, together with further objects and advantages thereof, may best be understood by reference to the following description, taken in conjunction with the following drawings.

### DESCRIPTION OF THE DRAWINGS

FIG. 1 is a schematic perspective view of a tiered planter incorporating the principles of the present invention.

FIG. 2 is a schematic side elevational view of the FIG. 1 tiered planter.

FIG. 3 is a schematic rear elevational view of the FIG. 1 tiered planter.

FIG. 4 is a detailed sectional view taken generally along lines IV-IV of FIG. 2.

FIG. 5 is a detailed sectional view taken generally along lines V-V of FIG. 4.

FIG. 6 is a schematic perspective view of an alternative embodiment of a tiered planter incorporating the principles of the present invention.

FIG. 7 is a detailed sectional view taken generally along lines VII-VII of FIG. 2.

### DETAILED DESCRIPTION OF THE INVENTION

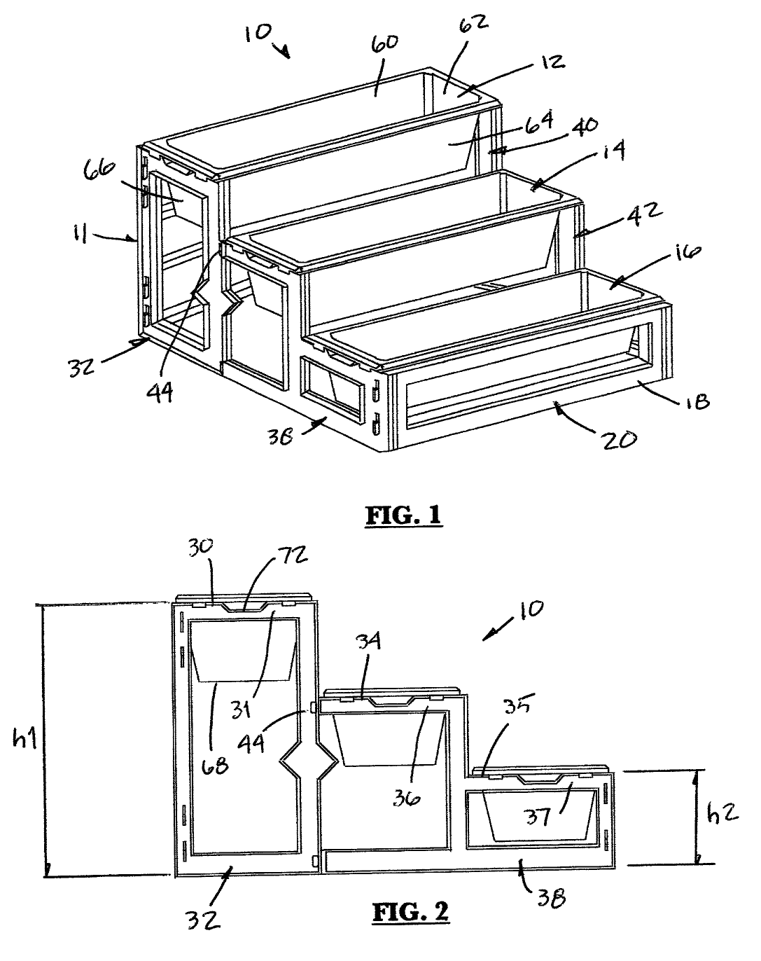

FIGS. 1 through 3 illustrate a tiered planter 10 adapted to hold a plurality of planter boxes 12, 14, and 16 in a tiered configuration. The planter 10 includes a frame assembly 11 including a front frame member 18, here illustrated as a front cross support 20, and a back frame member 22 (FIG. 3) illustrated as a top rear cross support 24 and a bottom rear cross support 26. The back frame member 22 has a height hi greater than a height h2 of the front frame member 18 FIG. 2.

At least one top frame member 28 is connected to the front frame member 18 and to the at least one back frame member 22. In the embodiment illustrated in FIGS. 1-5, the top frame member 28 includes an upper surface 30 of a top element 31 of a left rear side support 32, and upper surfaces 34 and 35 of top elements 36 and 37 of a left front side support 38. The top frame member 28 also includes similarly positioned upper surfaces on a right rear side support 40 and a right front side support 42. The upper surfaces of the side supports form planter box supports for the planter boxes 12, 14, and 16.

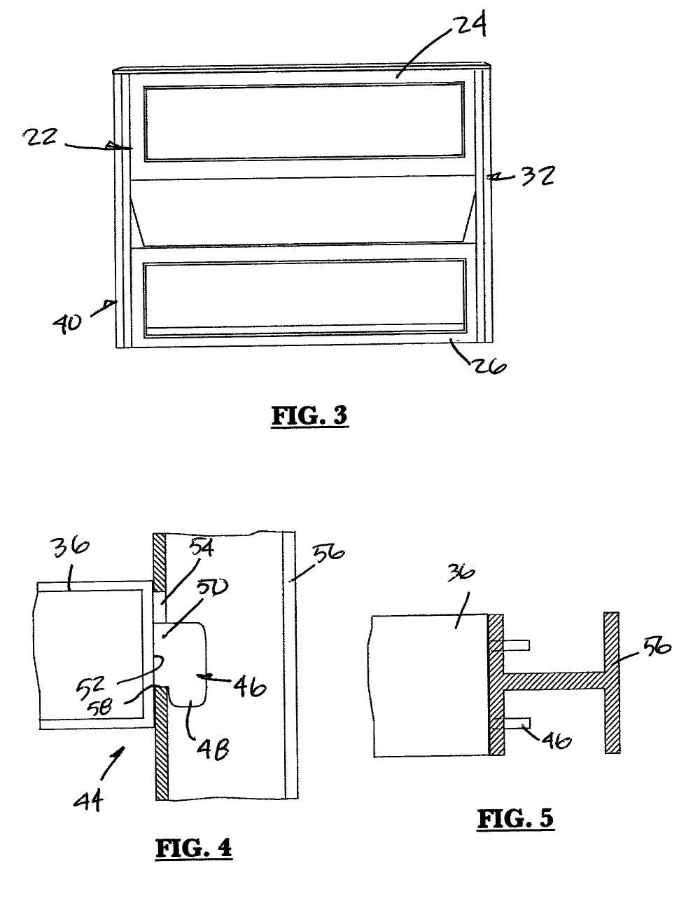

In the embodiment illustrated in FIGS. 1-5, the left front side support 38 is connected to the left rear side support 32, and the right front side support 42 connected to the right rear side support 40. Similarly, the front cross support 20 is connected between the left and right front side supports 38, 42, and the rear cross supports 24, 26 are connected between the left and right rear side supports 32, 40. All of these connections are made in a manner providing both secure connections and easy assembly and disassembly. It has been found that particularly advantageous connections can be made using a plurality of tab-and-slot mechanisms 44. Illustrated in detail in FIGS. 4 and 5, the tab-and-slot mechanisms 44 include a tab 46 including a retaining portion 48 and a connecting portion 50, here shown as extending from an end 52 of the top element 36. A slot 54 is provided in an upright element 56 of the side support 32. The slot 54 has dimensions to allow the tab 46 to pass therethrough, and is provided with a bottom surface 58 adapted to lock against the retaining portion 48 of the tab 46. As shown in FIG. 5, the tab-and-slot mechanisms can be provided as a pair of horizontally parallel tabs adapted and constructed to interlock with a corresponding pair of horizontally parallel slot s to provide additional stability.

Each of the planter boxes 12, 14, and 16 has four side walls 60, 62, 64, and 66, a bottom 68 connecting the four side walls, and an open top 70. The planter boxes 12, 14, and 16 are adapted and constructed to contain live plant material and plant growing medium (not shown). The planter box supports are adapted and constructed to removably secure the planter boxes in a tiered configuration with each of the respective tops of the planter boxes being secured at different heights. In the embodiment illustrated in FIGS. 1-5, the frame assembly 11 is provided with recesses 72 to facilitate grasping the planter boxes 12, 14, and 16 for ease of placement and removal. The planter boxes 12, 14, and 16 are also provided with alignment protrusions 74 that bear against the frame assembly 11 to ensure proper positioning of the planter boxes 12, 14, and 16 within the frame assembly 11.

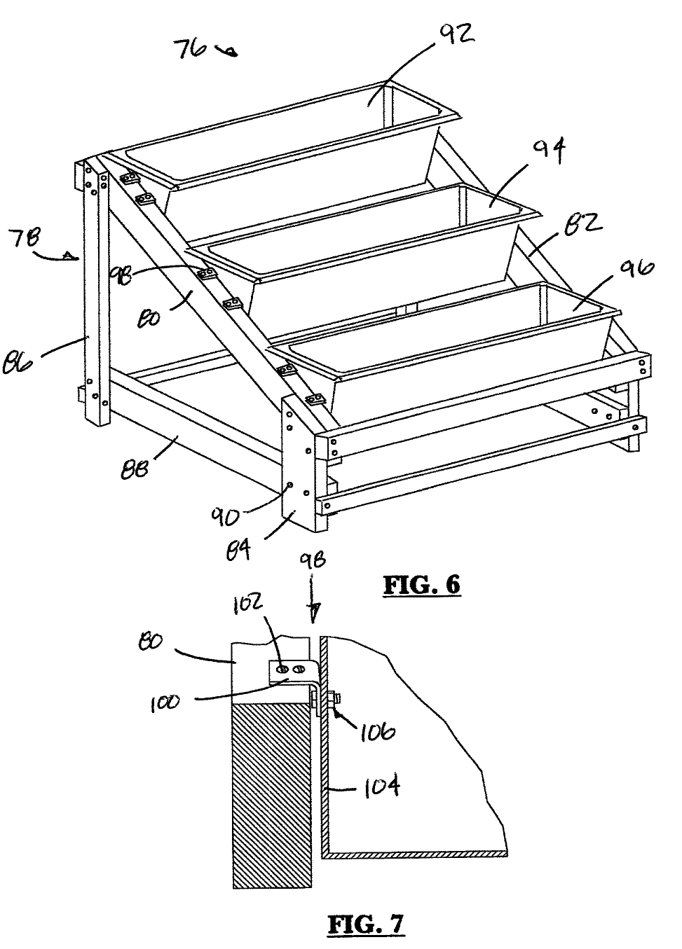

FIGS. 6 and 7 illustrate an alternative embodiment of a tiered planter 76 in accordance with the principles of the present invention. The tiered planter 76 includes a frame assembly 78 in which a pair of substantially straight top frame members 80, 82 are connected to form a downwardly extending angle between a front frame member 84 and a back frame member 86. A plurality of reinforcing cross members 88 are provided to add stability. The frame assembly 78 can be fabricated from any suitable material, such as wood or plastic. The various components of the frame assembly 78 can be secured together using suitable fasteners, such as screws 90.

A plurality of planter boxes 92, 94, and 96, similar to those in the FIG. 1 embodiment, are secured to the frame assembly 78 via a plurality of planter box supports 98. As seen in FIG. 7, each of the planter box supports 98 can be provided as an L-bracket 100 secured to the top frame members 80, 82 by fasteners such as screws 102, and to a sidewall 104 of the planter boxes by a fastener such as a threaded bolt assembly 106. This arrangement removably secures the planter boxes in a tiered configuration with each of the respective tops of the planter boxes being secured at different heights.

Although the present invention has been described with reference to specific embodiments, those of skill in the art will recognize that changes may be made thereto without departing from the scope and spirit of the invention as defined by the appended claims.

What is claimed is:

1. A tiered planter comprising the following:
a frame assembly including at least one front frame member having a height, at least one back frame member having a height greater than that of the at least one front frame member, and at least one top frame member connected to the at least one front frame member and to the at least one back frame member;
a plurality of planter boxes, each planter box having a four side walls, a bottom connecting the four side walls, and an open top, the planter boxes being adapted and constructed to contain live plant material and plant growing medium; and
a plurality of planter box supports connected to the frame assembly, the planter box supports being adapted and constructed to removably secure the planter boxes in a tiered configuration with each of the respective tops of the planter boxes being secured at different heights.

2. A tiered planter in accordance with claim 1, wherein the front and rear frame members comprise cross supports.

3. A tiered planter in accordance with claim 2, wherein the top frame member comprises top elements of a plurality of side supports.

4. A tiered planter in accordance with claim 3, wherein the planter box supports comprise upper surfaces of the top elements.

5. A tiered planter in accordance with claim 4, wherein the side supports comprise a left front side support connected to a left rear side support, and a right front side support connected to a right rear side support.

6. A tiered planter in accordance with claim 5, further comprising tab-and-slot mechanisms connecting the left front side support to the left rear side support and the right front side support to the right rear side support.

7. A tiered planter in accordance with claim 6, wherein each of the tab-and-slot mechanisms comprises a pair of horizontally parallel tabs adapted and constructed to interlock with a corresponding pair of horizontally parallel slot s.

8. A tiered planter in accordance with claim 5, wherein the cross supports comprise at least one front cross support connected between the left and right front side supports, and at least one rear cross support connected between the left and right rear side supports.

9. A tiered planter in accordance with claim 8, further comprising tab-and-slot mechanisms connecting the at least one front cross support connected between the left and right front side supports, and at least one rear cross support connected between the left and right rear side supports.

10. A tiered planter in accordance with claim 8, wherein the at least one front cross support, the left and right front side supports, the at least one rear cross support, and the left and right rear side supports are fabricated from a plastic material.

11. A tiered planter in accordance with claim 1, wherein the at least one top frame member comprises at least one substantially straight top frame member connected to form a downwardly extending angle between the at least one front frame member and the at least one back frame member.

12. A tiered planter in accordance with claim 1, wherein the frame assembly is fabricated from wood.

13. A tiered planter comprising the following:
a plurality of planter boxes, each planter box having a four side walls, a bottom connecting the four side walls, and an open top, the planter boxes being adapted and constructed to contain live plant material and plant growing medium;
a frame assembly including a front frame member having a height, and at least one back frame member having a height greater than that of the at least one front frame member, the at least one back frame member being removably connected to the at least one back frame member, with the plurality of planter boxes being adapted and constructed to be removably secured to the frame assembly in a tiered configuration, with each of the respective tops of the planter boxes being secured at different heights.

14. A tiered planter in accordance with claim 13, further comprising at least one side support connecting the front and rear frame members together.

15. A tiered planter in accordance with claim 14, wherein the side supports comprise a left front side support connected to a left rear side support, and a right front side support connected to a right rear side support.

16. A tiered planter in accordance with claim 55, further comprising tab-and-slot mechanisms connecting the left front side support to the left rear side support and the right front side support to the right rear side support.

17. A tiered planter in accordance with claim 16, wherein each of the tab-and-slot mechanisms comprises a pair of horizontally parallel tabs adapted and constructed to interlock with a corresponding pair of horizontally parallel slot s.

18. A tiered planter in accordance with claim 15, wherein the cross supports comprise at least one front cross support connected between the left and right front side supports, and at least one rear cross support connected between the left and right rear side supports.

19. A tiered planter in accordance with claim 18, further comprising tab-and-slot mechanisms connecting the at least one front cross support connected between the left and right front side supports, and at least one rear cross support connected between the left and right rear side supports.

20. A tiered planter in accordance with claim 8, wherein the at least one front cross support, the left and right front side supports, the at least one rear cross support, and the left and right rear side supports are fabricated from a plastic material.
